(19) United States
(12) Patent Application Publication
(10) Pub. No.: US 2004/0132367 A1
(43) Pub. Date: Jul. 8, 2004

(54) Multi-layer garment system

(76) Inventor: Moshe Rock, Brookline, MA (US)

Correspondence Address: FISH & RICHARDSON PC, 225 FRANKLIN ST, BOSTON, MA, 02110, US

(21) Appl. No.: 10/663,091

(22) Filed: Sep. 15, 2003

Related U.S. Application Data
(63) Continuation-in-part of application No. 10/122,024, filed on Apr. 12, 2002.
Application No. 10/122,024 is a continuation-in-part of application No. 09/982,720, filed on Oct. 18, 2001.
Application No. 09/982,720 is a continuation-in-part of application No. 09/883,643, filed on Jun. 18, 2001, now abandoned.
Application No. 09/883,643 is a division of application No. 09/347,825, filed on Jul. 2, 1999, now abandoned.

(51) Int. Cl. B32B 33/00; D05C 17/00; B32B 3/02; B32B 27/04; B32B 5/22

(52) U.S. Cl. 442/76; 428/91; 442/85; 442/79

(57) ABSTRACT

A multi-layered garment system including a primary garment including a thermal layer with at least one raised surface and an outer shell garment including a body constructed of a tightly woven fabric. The shell fabric is breathable, water repellent, and wind resistant. The body of the shell has an upper portion and a lower portion. A vapor permeable moisture barrier that is waterproof and windproof covers the upper portion of the body.

### TECHNICAL FIELD

This application is a continuation-in-part of U.S. application Ser. No. 10/122,024, filed Apr. 12, 2002 which is a continuation-in-part of U.S. application Ser. No. 09/982,720, filed Oct. 18, 2001, which is a continuation-in-part of U.S. application Ser. No. 09/883,643, filed Jun. 18, 2001, now abandoned, which is a division of U.S. application Ser. No. 09/347,825, filed Jul. 2, 1999, now abandoned, the entire disclosures of all of which are incorporated herein by reference.

This invention relates to garments, and more particularly to multi-layer garment systems.

### BACKGROUND

When a person wears a garment that is not moisture vapor transmissive during periods of physical activity, moisture in the form of perspiration is generally trapped within the garment and cannot escape to evaporate. On the other hand, when the person wears a garment which does not have wind barrier properties, air moving relative to the person, such as blowing wind, passes through or enters the garment and as a result the person may feel uncomfortably chilly or cold. Garments made of woven, knit or mesh fabric material, such as cotton, polypropylene, nylon, polyester, spandex or numerous other materials that are worn next to the skin permit perspiration from the person wearing the garment to escape and evaporate. However the garments are still susceptible to wind chill.

Jackets have been developed to handle wind and inclement weather. These garments, commonly referred to as “shell jackets”, are not only wind resistant but also generally offer water resistance. Shell jackets typically include a textile having a porous membrane layer for vapor permeability and a hydrophobic layer to shed rain.

Jacket liners have also been developed that can be worn inside a shell jacket to provide an insulation layer. These liners may be made, for example, of a fleece material. The jacket liner will trap the wearer's body heat, and thus protect the wearer from the cold, e.g., during periods of long exposure to the cold and periods of low activity.

Shell jackets may include vents that can be selectively opened to allow cooling air into the jacket. For example, vents commonly referred to as “pit zips” have been incorporated in shell jackets to provide ventilation to the underarm area of the wearer. Other attempts at increasing ventilation in a garment involve using a wind barrier fabric only in selected areas, generally the front of the garment, and a more breathable material in other areas, e.g., a mesh material in the back or vents that may be selectively opened and closed. The vents and mesh are air-permeable but offer little protection from wind and rain.

### SUMMARY

In one aspect, the invention features a multi-layer garment system including a primary garment that includes a thermal layer with at least one raised surface and an outer shell garment including a body constructed of a tightly woven fabric. The fabric is breathable, water repellent, and wind resistant. The body defines an upper portion and a lower portion. A vapor permeable moisture barrier covers the upper portion of the body. The moisture barrier is waterproof and windproof. The upper portion of the body includes a shoulder surface and a top sleeve surface. At least part of the lower portion is not covered by the moisture barrier.

The thermal layer may include a compartment for receiving the outer shell, for example a pouch within a pocket associated with the thermal layer. The shell may be connected to the thermal layer at the pouch. Alternatively, the shell may be removable and connected to the thermal layer at the waist, wrist and neck. Buttons, snaps, or hook-loops may be used to connect the shell to the thermal layer.

The fabric of the lower portion of the shell provides an air permeability of between about 1 and 5 cfm (cubic feet per minute) in 30 mph (miles per hour) wind. The fabric of the upper portion of the shell provides an air permeability of about 2 cfm or less in 30 mph wind. The thermal layer fabric may include fleece, double-face velour, Polartec® Thermal Pro® fabric, or Polartec® Classic® fabric. The upper portion of the shell fabric may include Gore-Tex® fabric. The lower portion of the shell fabric may include Polartec® Wind Pro® fabric.

Embodiments of the invention may have one or more of the following advantages. The garment combines the warmth and breathability of modern fleece fabrics, which are typically suitable to be worn in comfort most of the time, with the wind and waterproof qualities of a lightweight shell. In periods of high activity like running, hiking and climbing, the thermal layer and shell allow perspiration to escape, due to the relatively high breathability of the lower portion of the shell. The use of a moisture barrier only in selected areas of the shell garment offers protection against wind and light rain, without unduly compromising breathability and ventilation.

While the upper portion of the shell provides protection against wind and rain, the shell's lower portion provides circulation by allowing moisture generated by the wearer to escape. The shell jacket also provides protection against the wind when moving air is encountered during activities such as bicycling, roller skating, or motorcycling which often produce a wind chill effect. Preferred garment systems can be worn in comfort during a variety of conditions and activities.

In some embodiments, the primary garment includes a pouch to store the shell during periods when the user does not need the added protection of the shell. When the shell is not needed it is folded up and stored in a pocket in the thermal layer. The user does not have to worry about finding a location to store the shell or be concerned about the possibility of misplacing the shell. When the shell is needed the user can easily remove the shell from the pouch and wear it over the thermal layer. In some embodiments, the shell fastens to the thermal layer to provide a harmonized thermal, wind, and water resistant garment. The person does not need to worry about misplacing the shell or forgetting to pack the shell during periods of inclement weather.

The details of one or more embodiments of the invention are set forth in the accompanying drawings and the description below. Other features, objects, and advantages of the invention will be apparent from the description, drawings, and from the claims.

### DESCRIPTION OF DRAWINGS

FIG. 1 is a frontal view of a multi-layer garment system according to one embodiment of the invention, with a portion of the shell cut away to show the underlying thermal layer.

FIG. 2 is a rear view of the multi-layer garment system.

FIG. 3A is an enlarged profile perspective of the fabric of the front portion fabric of the thermal layer.

FIG. 3B is an enlarged profile perspective of the fabric of the back portion fabric of the thermal layer.

FIG. 3C is an enlarged front view of the fabric of the back portion of the thermal layer.

FIG. 3D is an enlarged profile perspective of the fabric of the sleeve portion of the thermal layer.

FIG. 4A is diagonal view of the thermal layer according to one embodiment.

FIG. 4B is a diagonal view of the thermal layer according to another embodiment.

FIG. 5 is a diagrammatic, highly enlarged perspective view of the thermal layer and the layer's transmissive properties.

FIG. 6 is a diagrammatic, highly enlarged perspective view of the primary garment and the garment's transmissive properties.

FIG. 7 is a chart contrasting characteristics of three styles of fabric relative to wind speed.

FIG. 8 is a frontal view of a multi-layer garment system according to an alternate embodiment of the invention.

FIG. 9 is a frontal view of a thermal layer with a pouch to store a shell.

Like reference symbols in the various drawings indicate like elements.

### DETAILED DESCRIPTION

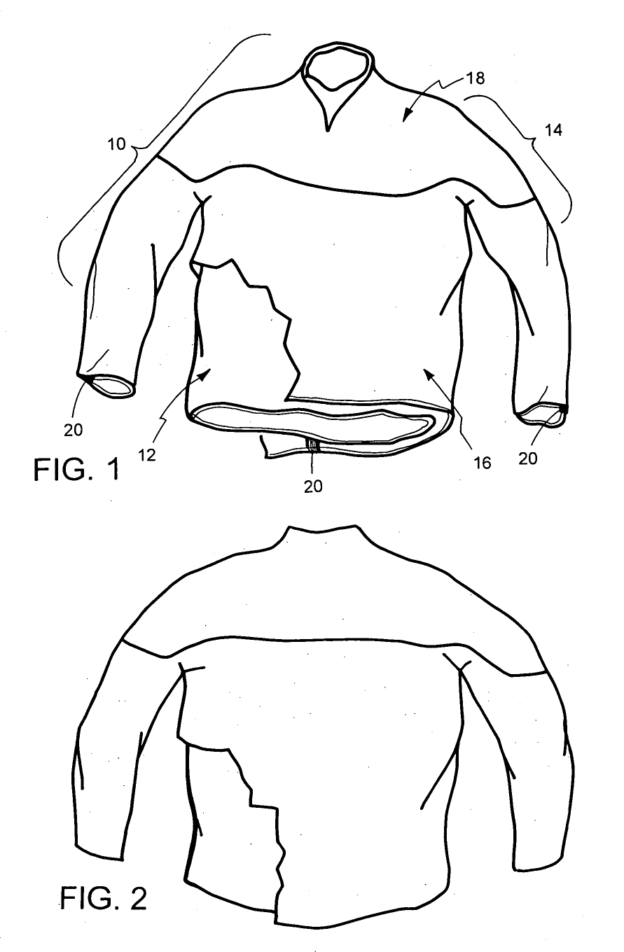

Referring to FIGS. 1 and 2, a multi-layer garment system 28 includes a primary garment 10 that consists of a thermal layer 12, and a shell 14. The thermal layer 12 is made of a fleece material, e.g., any one of the many fleece or insulation materials that are commonly included in garments used for everything from Himalayan expeditions to back-to-school jackets. Suitable fleece materials include, for example, fleece materials that are commercially available from Malden Mills Industries, Inc. under the tradename Polartec® Classic® fleece products. Fleece materials are available in a variety of weights, colors, and textures. Another suitable fleece material is a double-face velour fabric described in U.S. Pat. No. 6,196,032. The double-face velour provides improved dynamic insulation performance while avoiding increased weight and/or loss of stretch or flexibility. Polartec Windpro® fabric available from Malden Mills, Inc., is an example of double-face velour.

Other suitable materials for use in the thermal layer 12 include insulating textiles that have at least one raised surface. For example, suitable textiles having a raised surface include high loft sweater-knits and micro-grid fabrics, such as those commercially available from Malden Mills Industries, Inc. under the tradename Polartec® Thermal Pro® fabrics.

In most environments, the user can wear the thermal layer 12 comfortably without the shell 14. The fleece thermal insulation properties allow the user to comfortably wear the thermal layer 12 indoors and outdoors. The thermal layer 12 provides a soft texture against the skin and provides a soft texture on the outside, which is exposed when the shell 14 is removed.

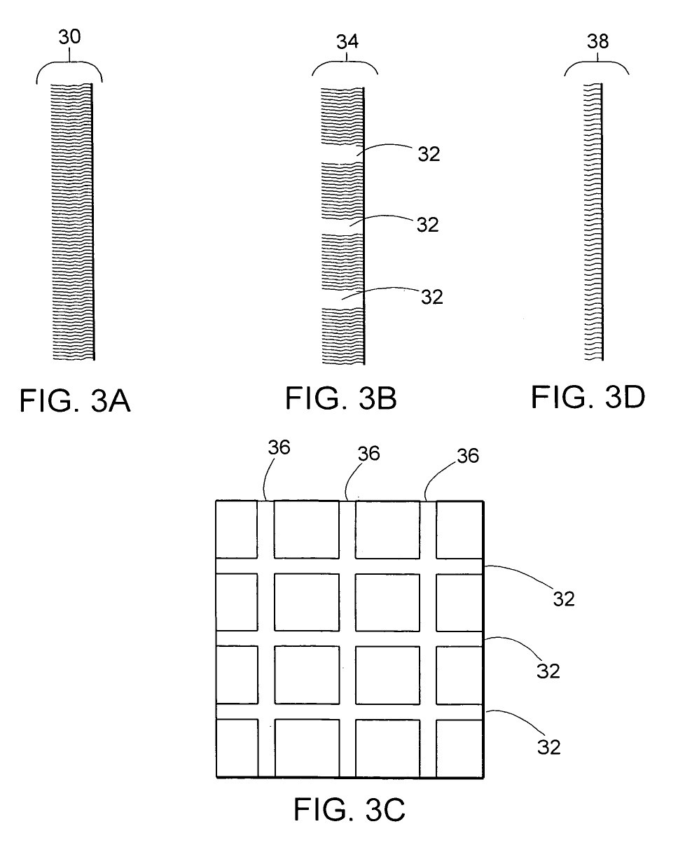

To provide enhanced comfort to the user, the thermal layer 12 can comprise multiple types of fabric for the different regions of the body covered by the thermal layer 12. By providing a combination of fabrics the thermal layer 12 can be tailored to the thermal needs of specific body regions. The front part of the thermal layer can have a very low air permeability of 30-50 cfm (ASTM D-737), to reduce the convective heat loss when a person is running, jogging, or hiking. The front fabric (technical face) yarn components can include a jersey 70/68 tex (textured filament yarn with 70 denier with 68 filament) polyester plaited spandex with a 70 denier. The technical back can be constructed with a plaited loop 70/68 tex polyester. After a raising process, this produces a technical back with a thick pile layer 30 as shown in FIG. 3A, which provides greater insulation.

The back part of the thermal layer can have constructed channels 32 within the pile layer 34 as shown in FIGS. 3B and 3C. The fabric can have horizontal channels 32 and vertical channels 36 as shown in FIG. 3C. The channel construction within the pile surface 34 provides a thermal insulation layer while allowing for air circulation within the channels 32 and 36. Channel construction is described in greater detail in U.S. patent application Ser. No. 10/047,939 the disclosure of which is incorporated herein by reference. The yarn components of the back part can include a jersey 70/68 tex polyester and loop 70/68 tex polyester to construct a plaited spandex with a 70 denier. This is similar to the front fabric but with channels constructed within the pile surface. The channel construction provides good insulation in static conditions or under a backpack, as well as good air movement (convective heat) and cooling effects in high activity. The neck area can also be made with the same fabric as the back to enhance cooling during high exertion. The channel construction enhances the garment system by providing air circulation underneath the shell. The shell layer limits air circulation due to the shell's wind breaking characteristics. The channel construction allows the limited air penetration of the shell to circulate the air within the channels between the thermal layer and shell layer.

The sleeves can have a raised surface with a lower pile height to reduce overheating. The sleeve's fabric yarn components comprise a jersey 70/68 tex polyester and loop 70/48 tex polyester to construct a plaited spandex with a 20 denier. The pile layer 38, as shown in FIG. 3D, is shorter and less thick. The shorter and less dense pile layer reduces overheating by allowing the body's natural heating system to regulate body temperature by controlling heat loss through the arms.

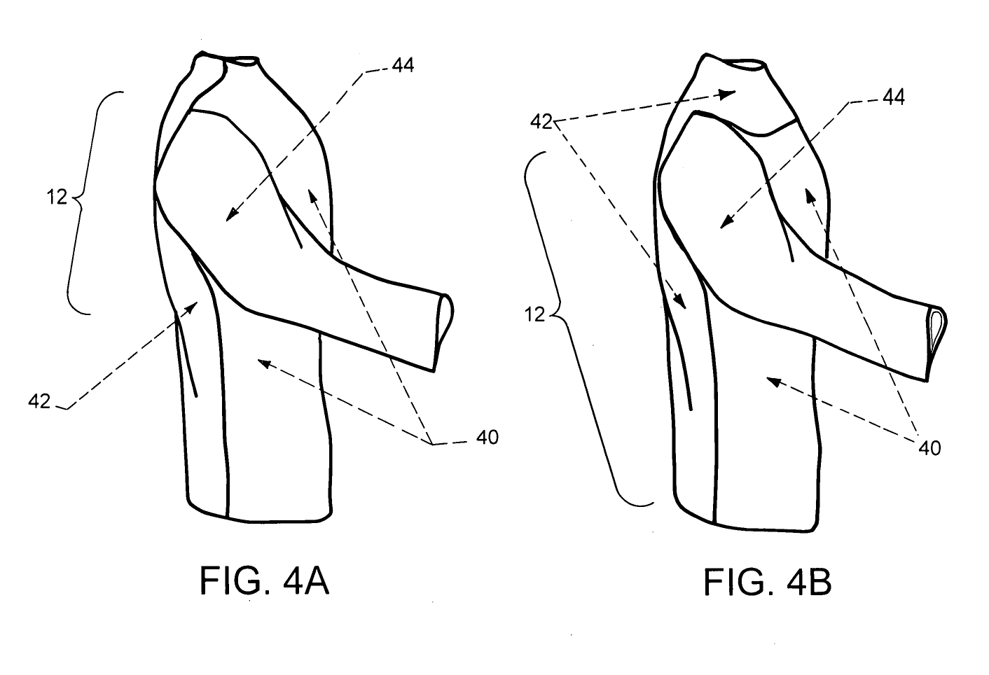

In FIG. 4A, the various fabrics are stitched together to make the thermal layer 12. The front layer 40 extends from the shoulders down the front of the garment to the waist. In one embodiment (not shown) the front layer can be divided down the center by a zipper. The back layer 42 extends from the shoulders down the back of the garment to the waist. The sleeves 44 extend from the shoulder down each arm to the waist.

In FIG. 4B the various fabrics are stitched together in a pattern slightly different from that shown in FIG. 4A. The back layer 42 extends over the shoulders and surrounds the neck of the garment. This provides enhanced air circulation over regions of the body that produce excessive heat during periods of high activity. In addition to extending the region covered by the back layer, the sleeves can also be divided into two separate layers. The bottom portion of the sleeves 46 extends from the armpit down along the underside of the arm to the wrist. This bottom sleeve portion 46 is constructed of a similar fabric to that of the upper sleeve portion 44, however, the pile layer can be even shorter and less dense. This gives the body's natural cooling system additional control by permitting cooling close to the arteries of the arm while preventing heat loss due to wind chill in the upper sleeve portion. The designs used to stitch the various fabrics are not limited to the above combination. A variety of patterns can be used to achieve the desired results.

The jersey side of each of the fabric components can be made of the same yarn and can be dyed with the same dyestuff. Using the same dyestuff reduces the metameric flare of exposing it to different sources of light. The result is a silhouette with a solid color. The fabric components can also be dyed individually to contrast the various components of the thermal layer 12.

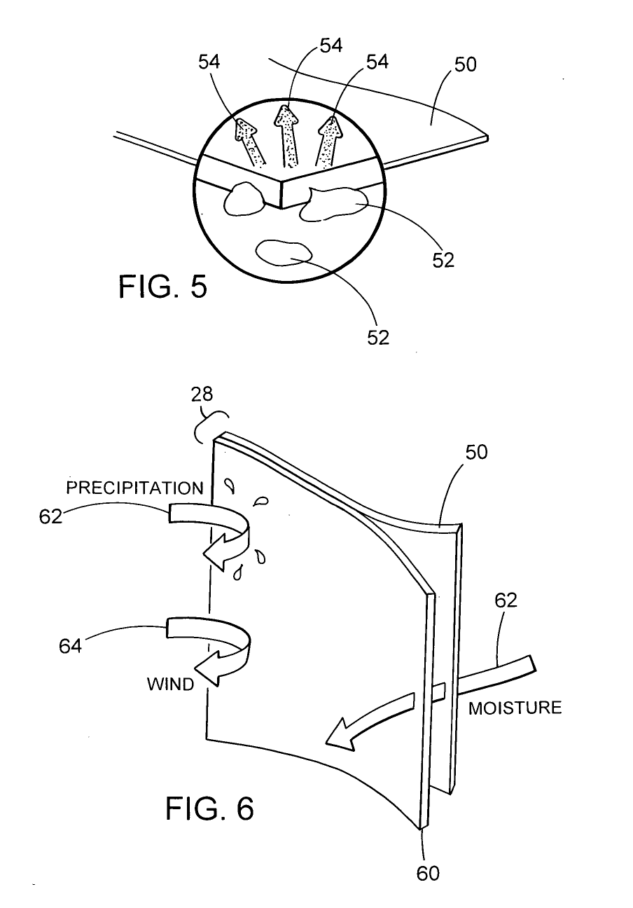

As the user becomes more active, the user's body produces heat and moisture. Referring to FIG. 5, the thermal layer 12 made of fabric 50 is designed to wick away moisture 52 and minimize heat loss. The perspiration 52 generated by the user is pulled through the fabric 50 and allowed to escape as vapor 54 on the opposite face of the fabric 50. The thermal layer 12, worn close to the skin, should be breathable and non-absorbent. The fabric 50 wick the moisture away from the user and not absorb or hold the moisture next to the user. This allows the fabric 50 to aid the person's natural cooling process by allowing perspiration vapor to escape and regulating the temperature next to the person's skin. This fabric 50 allows the user to stay dry and comfortable when the user is active, with no perspiration buildup to make the user cold.

The shell 14 has a lower portion 16 and an upper portion 18. The lower portion 16 is made of a fabric that provides wind and water resistance. A wind resistant fabric is a fabric having an air permeability between 1 cubic feet per minute (cfm) and 10 cfm (measured using the air permeability test method ASTM D-737). This level of wind resistance generally prevents heat loss from convection. Wind resistance is based on the wind speed relative to the person, which is often more pertinent in action sports. For example, a person biking at 10 miles/hour (mph) into a 5 mph headwind would feel a total wind speed of 15 mph.

A water resistant fabric is a fabric that uses a coating or dense weave to prevent saturation of a garment. Water resistant fabrics shed or repel water. The have a very good water repellence and provide some resistance to hydrostatic pressure. However, they are not waterproof. Unlike a waterproof fabric with a very high resistance to hydrostatic pressure, water resistant fabrics are not able to withstand water entry pressure resulting from active use in extended wet weather and will become wet when exposed to these conditions. Water resistance is measured using a variety of tests, such as water repellency rating using method AATCC 22-1980, hydrostatic pressure rating using method ASTM D751, and moisture vapor transmission rating using method ASTM E-96. The fabric of the lower portion 16 is not only wind and water resistant but also lightweight and comfortable.

The upper portion 18 can be made waterproof. A waterproof fabric must be able to resist water entry under hydrostatic pressure resulting from active use in extended wet weather. These activities include walking in wind-driven rain or kneeling or sitting on a wet surface. The upper portion provides protection against precipitation while allowing the shell to maximize breathability and comfort.

Suitable fabrics for the shell include waterproof breathable textiles that are laminated or coated with a hydrophobic porous or non-porous membrane layer. An example of this type of fabric is a woven, nylon or polyester, with about a 180×120 yarn count, and about a 30/26 FF yarn (a finesse of 30 denier with 26 strands and the yarn is filament and flat, i.e. straight without crimp or texture). This type of fabric would typically produce an air permeability of about 6 cfm and very good water repellence. The entire shell 14 is constructed of the same fabric with the upper portion 18 being covered with a breathable membrane. The membrane increases the fabric's wind and water resistance while maintaining a degree of breathability. The membrane can be applied as a laminate or a coating. The laminate can comprise a breathable membrane of PTFE, polyurethane, or polyester polyether. The coating can comprise a polymer selected from the group consisting of acrylic, polyurethane, or silicon polymer. The uncoated or unlaminated lower shell fabric 16 provides resistance to wind and rain and high dynamic breathability. The combination of protection maximizes breathability and resistance to the elements. This method of construction also reduces the number of seams of the shell, thereby increasing the shell's resistance to water and decreasing manufacturing costs.

The upper portion 18 may extend from the collar of the garment, over the shoulders, and midway down the upper arm of the garment as shown in FIGS. 1 and 2. Avoiding the placement of seams on the shoulders provides greater protection from water and wind penetrating the seams. By placing the seam under the arms, on the chest, and on the back below the shoulders, the seams are protected from the maximum kinetic energy of falling rain.

A highly enlarged view of garment system 28 is shown in FIG. 6. The garment system provides protection against the outside elements while allowing the body to regulate the temperature of the user. As discussed above, the garment system 28 includes thermal layer 12 and shell garment fabric 14. The thermal layer 12 allows moisture 62 to escape while providing insulation to prevent heat loss. The shell 14 provides a barrier against precipitation 62 and wind 64. The shell fabric also allows moisture 62 to escape and prevents moisture buildup between the fabric 50 of thermal layer 12 and the fabric 60 of shield 14. The combination of fabrics allows the user to stay dry and comfortable in a variety of environments and during a variety of activities.

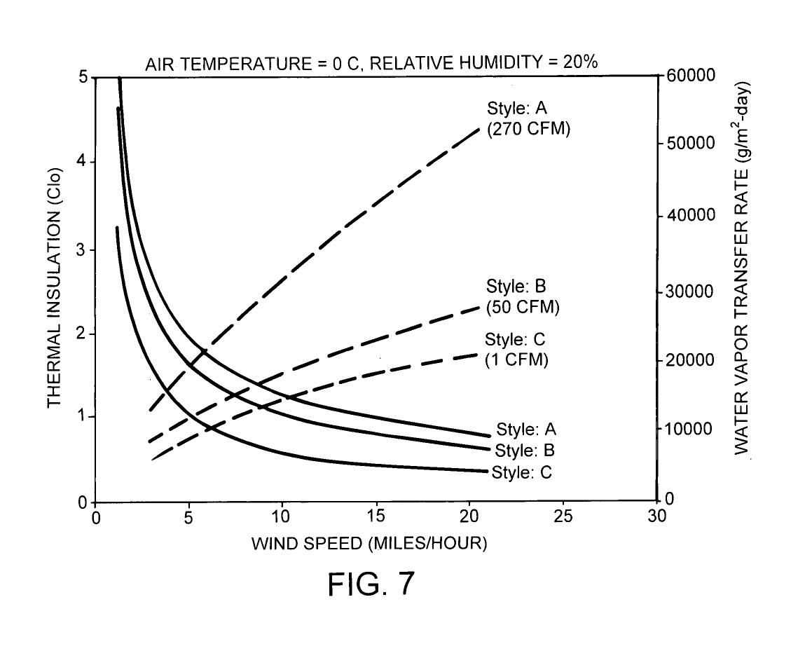

FIG. 7 shows the characteristics of three different styles of fabric as the wind speed changes. The solid lines show the effect of wind speed in miles/hour on thermal insulation in “Clo”. A Clo is a unit used to measure clothing insulation. Typically the units of Clo equal 0.15 times the weight in pounds (lbs) of clothing. For example, a human wearing 10 lbs of clothing would be wearing clothing that provides an insulation value of 1.5 Clo. As wind speed increases the thermal insulation value decreases for all three styles of fabric. The dotted lines show the effect of wind speed (in miles/hour) on water vapor transfer rate (grams/meter²×day). As wind speed increases the water vapor transfer rate also increases. Style A, rated at 270 cfm, would be similar to a lightweight fleece. Style A provides excellent insulation at relatively low wind speeds. However, as wind speed increases, the insulation value drops significantly. The vapor transfer rate also climbs significantly. Style C provides greater protection from vapor transfer at high wind speeds. At low wind speeds, style C provides similar protection to that of style A. However, when the wind speed is increased, the vapor transfer rate is nearly half that of style A. Style C rated at 1 cfm would be similar to a fabric like Polartec® Power Shield®. Style B provides a mid-range fabric and would be similar to the Polartec® Wind Pro® fabric. The chart provides a guide for selecting fabrics for the thermal layer and shell. The user's comfort can be maximized by selecting a combination of fabrics based the principal environment and user activity.

Polartec® Wind Pro® fabric, a versatile fabric for all four seasons and a range of activities, is an example of a suitable fabric for shell 14. Polartec® Wind Pro® uses micro-fibers and a very tight knit construction to create a fabric that is 4-5 times more wind resistant than traditional fleece yet retains 85% of the breathability. A 4-way stretch version of this fabric has a sheer face, which significantly improves durability and water repellency four-way stretch versions are commercially available from Malden Mills Industries, Inc. under the tradenames Polartec® Power Shield® and Polartec® Aqua Shell® fabrics. The shell 14 is not limited to the above fabrics. The shell fabric can be woven non-stretch or stretch in one direction or both directions. The shell 14 can contain elastomeric yarn, such as spandex or lycra.

Suitable fabrics for shell 14 preferably provide warmth and wind protection in action speed sports like cycling and skiing. Suitable fabrics for the shell 14 are generally tightly-woven and light weight. The shell fabric should also be relatively breathable. The seams of the garment may also be sealed to add additional protection against wind and water. For example, a thermoplastic film made of polyurethane can be used to tape the seams.

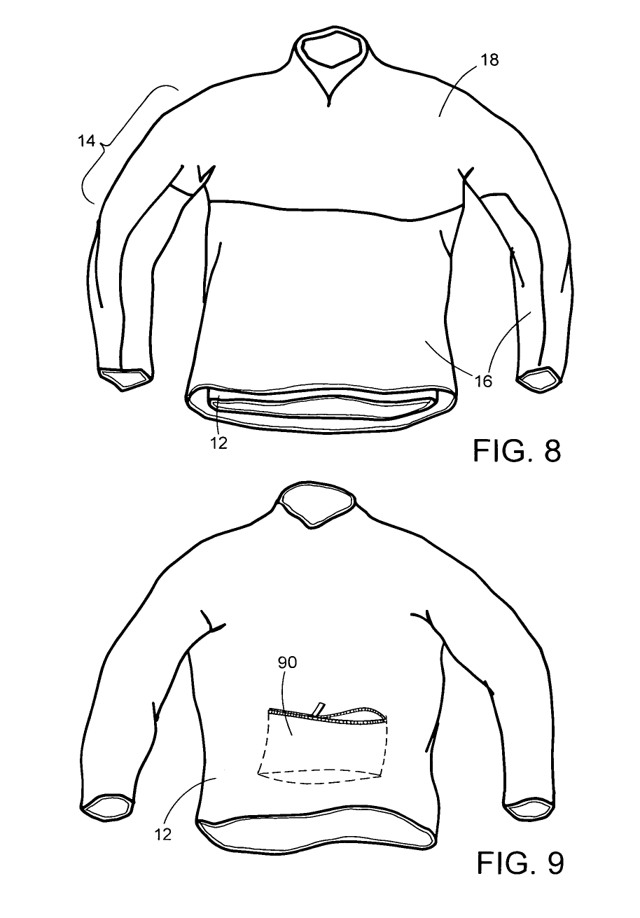

In FIG. 8, the upper portion 18 of the shell 14 covers the shoulder region and extends below the elbow down the entire length of the arm. In another embodiment (not shown), the upper portion 18 may completely cover the surface of the shell 14 except high perspiration regions of the body, i.e., under the arms. The more complete coverage of the upper portion 18 can produce a garment that offers enhanced resistance in extremely wet and windy environments.

In one embodiment, the upper portion of the shell can be made of a separate fabric from the lower portion. The upper and lower fabrics are stitched together to form the shell. In this embodiment the lower portion of the shell is constructed of the same fabric as the previous embodiment. An example of a typical fabric of the upper portion is a woven, nylon or polyester, with about a 182×104 yarn count, and a 40/34 FF yarn (a finesse of 40 denier with 34 strands and the yarn is filament and flat, i.e. straight without crimp or texture). This type of fabric would typically produce an air permeability of about 2.5 cfm and very high hydrostatic pressure. This combination of fabrics maximizes the breathability of the garment and protection against the elements.

In the embodiment shown in FIG. 9 the primary garment 11 has a pocket 90. The shell is stored within the pocket 90 during periods when the environment or activity does not require the user to wear the shell 14 over the primary garment 11. When a change in condition requires the user to wear the shell 14, the user removes the shell 14 and puts it on over the primary garment 11. The shell 14 can also be attached to the primary garment with fasteners 20 at the waist, wrist, and neck as shown in FIG. 1. Buttons, snaps, or hook-loops are examples of possible fasteners 20 that allow the two layers of the multi-layer garment 10 to function as one.

A number of embodiments of the invention have been described. Nevertheless, it will be understood that various modifications may be made without departing from the spirit and scope of the invention. Accordingly, other embodiments are within the scope of the following claims.

What is claimed is:

1. A multi-layer garment system, comprising:
a primary garment including a thermal layer with at least one raised surface; and an outer shell garment constructed to be worn over the primary garment, including
a first portion comprising a fabric that is breathable, water repellent, and wind resistant, the body defining an upper portion and a lower portion, and
a second portion comprising a vapor permeable moisture barrier that is substantially waterproof and windproof.

2. The system of claim 1 wherein the shell garment is formed entirely of the fabric.

3. The system of claim 2 wherein the vapor permeable moisture barrier comprises a coating formed on the fabric.

4. The system of claim 3 wherein the coating comprises a polymer selected from the group consisting of acrylic, polyurethane, silicon polymer.

5. The system of claim 2 wherein the vapor permeable moisture barrier comprises a laminate formed on the fabric.

6. The system of claim 5 wherein the laminate comprises a breathable file of PTFE, polyurethane, polyester polyether.

7. The system of claim 1 wherein the second portion comprises a second fabric different from the fabric of the first portion.

8. The system of claim 1 or 5, wherein the first portion comprises a tightly-woven fabric.

9. The system of claim 5 wherein the second portion comprises a tightly-woven fabric with a lower air permeability than the first portion.

10. The system of claim 1 wherein the first and second portions comprise lower and upper portions, respectively, of a jacket.

11. The system of claim 10, wherein the upper portion of the jacket includes a shoulder surface and a top sleeve surface.

12. The system of claim 11 wherein the lower portion includes an underarm area of the jacket.

13. The system of claim 1, wherein the primary garment comprises a compartment for receiving the outer shell.

14. The system of claim 13, wherein the compartment is defined by a pouch or pocket associated with the primary garment.

15. The system of claim 1, wherein the first portion provides an air permeability of between about one and about ten cubic feet per minute in a thirty mile per hour wind.

16. The system of claim 1, wherein the second portion provides an air permeability of one cubic feet per minute or less in a thirty mile per hour wind.

17. The system of claim 1, wherein the thermal layer includes a fleece.

18. The system of claim 1, wherein the thermal layer includes a double-face velour.

19. The system of claim 1, wherein the thermal layer includes a channeled region constructed to provide circulation of air permeating through the first portion of the shell.

20. The system of claim 19, wherein the thermal layer includes a front portion having a raised surface extending from a shoulder region down over a chest region to a waistline and a back portion having a raised surface with channels within the raised surface and extending from the shoulder region down each arm.

21. The system of claim 20, wherein the thermal layer includes a pair of sleeve portions, each sleeve portion having a raised surface shorter than the raised surface of the front portion and extending from the shoulders region down each arm.

22. The system of claim 20, wherein the thermal layer includes a pair of sleeve portions, each sleeve portion having a raised surface less dense than the raised surface of the front portion and extending from the shoulders region down each arm.

23. The system of claim 20, wherein the back portion extends over the shoulder region and around a neckline and the front portion extends from the back portion down over a chest region to the waistline.

24. The system of claim 19, wherein the channeled region includes channels on the raised surface that run vertically and horizontally.

25. The system of claim 1, wherein the shell comprises a micro-fiber textile material.

26. The system of claim 1, wherein the thermal layer comprises a high loft, sweater-knit and micro-grid fabric.

27. The system of claim 1, wherein the thermal layer comprises a high loft of about 8/32 inch to about 12/32 inch on both front and back.

28. The system of claim 1, wherein the shell is releasably connected to the thermal layer at the waist, wrist and neck.

29. A lightweight shell garment for use with a primary garment, the shell comprising:
a first portion comprising a tightly-woven fabric, the fabric being breathable, water-repellent, and wind-resistant; and
a second portion comprising of a vapor permeable moisture barrier that is waterproof and windproof.

30. The lightweight shell of claim 29 wherein the first and second portions comprise lower and upper portions, respectively, of a jacket.

31. The lightweight shell of claim 30, wherein the upper portion of the jacket includes a shoulder surface and a top sleeve surface.

32. The lightweight shell of claim 29, wherein the first portion provides an air permeability of between about one and about ten cubic feet per minute in a thirty mile per hour wind.

33. The lightweight shell of claim 29, wherein the second portion of the body provides an air permeability of one cubic feet per minute or less in a thirty mile per hour wind.

34. The lightweight shell of claim 29 wherein the shell garment is formed entirely of the fabric.

35. The lightweight shell of claim 34 wherein the vapor permeable moisture barrier comprises a coating formed on the fabric.

36. The lightweight shell of claim 35 wherein the coating comprises a polymer selected from the group consisting of acrylic, polyurethane, silicon polymer.

37. The lightweight shell of claim 29 wherein the second portion comprises a second fabric different from the fabric of the first portion.

38. The lightweight shell of claim 29 or 37, wherein the first portion comprises a tightly-woven fabric.

39. The lightweight shell of claim 37 wherein the second portion comprises a tightly-woven fabric with a lower air permeability than the first portion.

40. The lightweight shell of claim 29, wherein the shell comprises a micro-fiber textile material.

41. A method of wearing a multi-layered garment, comprising:
wearing a primary garment including a thermal layer with at least one raised surface; and
wearing an outer shell garment constructed to be worn over the primary garment, including a first portion comprising a fabric that is breathable, water repellent, and wind resistant, a body defining an upper portion and a lower portion, and a second portion comprising a vapor permeable moisture barrier that is waterproof and windproof.

42. The method of claim 41, further comprising:
removing the outer shell garment, while continuing to wear the primary garment, and storing the outer shell in a compartment for receiving the outer shell.

43. The method of claim 42, wherein the compartment is defined by one of a pouch and a pocket associated with the primary garment.

44. A primary garment for use with a lightweight shell, the primary garment comprising:
a front portion comprising an insulating fabric having a raised surface, the front portion extending from a shoulder region down over a chest region to a waistline and
a back portion comprising an insulating fabric having a raised surface with channels within the raised surface, the back portion extending from the shoulder region down over a back region to the waistline.

45. The primary garment of claim 44 wherein the channels are constructed to circulate air flowing through the shell.

46. The primary garment of claim 44, further comprising:
a pair of sleeve portions each having a raised surface shorter than the raised surface of the front portion and extending from the shoulder region down each arm.

47. The primary garment of claim 44, further comprising:
a pair of sleeve portions each having a raised surface less dense than the raised surface of the front portion and extending from the shoulder region down each arm.

48. The primary garment of claim 44, wherein
the back portion extends over the shoulder region and around a neckline and the front portion extends from the back portion down over a chest region to the waistline.

49. The primary garment of claim 44, wherein
the channels of the raised surface run vertically and horizontally.

50. A multi-layer garment system, comprising:
a primary garment including a thermal layer, including
a front portion having a raised surface and extending from a shoulder region down over a chest region to a waistline,
a back portion having a raised surface with channels within a raised surface and extending from the shoulder region down over a back region to the waistline, and
a sleeve portion each having a raised surface shorter than the raised surface of the front portion and extending from the shoulders region down each arm and
an outer shell garment constructed to be worn over the primary garment, including
a body constructed of a fabric, the fabric being breathable, water repellent, and wind resistant, the body defining an upper portion and a lower portion, and
a vapor permeable moisture barrier covering said upper portion of the body, the moisture barrier being waterproof and windproof,
wherein at least part of said lower portion is not covered by said moisture barrier.
